(19) United States
(12) Patent Application Publication
(10) Pub. No.: US 2025/0118031 A1
(43) Pub. Date: Apr. 10, 2025

(54) DISPLAY CONTROL METHOD AND APPARATUS, ELECTRONIC DEVICE, AND STORAGE MEDIUM

(71) Applicant: Beijing Zitiao Network Technology Co., Ltd., Beijing (CN)

(72) Inventors: Zhanchen ZHANG, Beijing (CN); Dier NAN, Beijing (CN)

(21) Appl. No.: 18/911,946

(22) Filed: Oct. 10, 2024

(30) Foreign Application Priority Data
Oct. 10, 2023 (CN) 202311308124.1

(51) Int. Cl. G06T 19/00; G02B 27/00; G02B 27/01

(52) U.S. Cl. CPC G06T 19/006; G02B 27/0093; G02B 27/017; G02B 2027/0178

(57) ABSTRACT

The present disclosure provides a display control method and apparatus, an electronic device, and a storage medium. In the display control method, a display unit is communicatively connected to a processing unit, so that a user is able to view a real environment through the display unit. The method includes: displaying a user interface by the display unit, where the user interface includes: an image of the real environment presented through the display unit and target information generated by the processing unit; and controlling, in response to the head of the user being rotated in a first direction of rotation, the target information to rotate, in the user interface, relative to the head in a direction opposite to the first direction of rotation. In some embodiments of the present disclosure, the usage experience of a user is improved.

### CROSS-REFERENCE TO RELATED APPLICATION(S)

This application claims priority to Chinese Application No. 202311308124.1 filed Oct. 10, 2023, the disclosure of which is incorporated herein by reference in its entity.

### TECHNICAL FIELD

The present disclosure relates to the field of computer technologies, and in particular, to a display control method and apparatus, an electronic device, and a storage medium.

### BACKGROUND

In a mixed reality world, images of a real environment and some computationally generated display information can be displayed, and the display information can be displayed in a 0-degree-of-freedom mode, a 3-degrees-of-freedom mode, and a 6-degrees-of-freedom mode. When displayed in the 0 degree-of-freedom mode, the display information may not be fixed in an extended reality world, and thus is correspondingly rotated or moved totally with the rotation or movement of the head of a user; when displayed in the 3 degrees-of-freedom mode, the display information is relatively fixed in the extended reality space, and thus may be moved with the movement of the head of the user, but is not rotated with the rotation of the head of the user; and when displayed in the 6 degrees-of-freedom mode, the display information may be fixed in the extended reality world, and does not follow the movement or rotation of the head of the user.

### SUMMARY

The present disclosure provides a display control method and apparatus, an electronic device, and a storage medium.

The following technical solutions are used in the present disclosure.

In some embodiments, the present disclosure provides a display control method, where a display unit is communicatively connected to a processing unit, so that a user is able to view a real environment through the display unit. The method includes:
displaying a user interface by the display unit, where the user interface includes: an image of the real environment presented through the display unit and display target information generated by the processing unit; and
controlling, in response to the head of the user being rotated in a first direction of rotation, the target information to rotate, in the user interface, relative to the head in a direction opposite to the first direction of rotation.

In some embodiments, the present disclosure provides a display control apparatus. The apparatus includes:
a processing unit configured to generate target information and communicatively connected to a display unit, so that a user is able to view a real environment through the display unit;
a display unit configured to display a user interface, where the user interface includes: an image of the real environment presented through the display unit and target information generated by the processing unit; and
a control unit configured to control, in response to the head of the user being rotated in a first direction of rotation, the target information to rotate, in the user interface, relative to the head in a direction opposite to the first direction of rotation.

In some embodiments, the present disclosure provides an electronic device. The electronic device includes: at least one memory and at least one processor,
where the memory is configured to store program code, and the processor is configured to call the program code stored in the memory to perform the method described above.

In some embodiments, the present disclosure provides a computer-readable storage medium configured to store program code that, when executed by a processor, causes the processor to perform the method described above.

According to the display control method provided in the embodiments of the present disclosure, the image of the real environment and the target information are displayed in the user interface; and in response to the head of the user being rotated in the first direction of rotation, the target information is controlled to rotate, in the user interface, relative to the head in the direction opposite to the first direction of rotation. In some embodiments of the present disclosure, the problem of a poor usage experience of the user in the 0-degree-of-freedom display mode is solved.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic diagram of using a mixed reality device according to an embodiment of the present disclosure;

FIG. 2 is a flowchart of a display control method according to an embodiment of the present disclosure;

FIG. 3 to FIG. 6 are schematic diagrams of target information and a user according to embodiments of the present disclosure; and

FIG. 7 is a schematic diagram of a structure of an electronic device according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifier “one” mentioned in the present disclosure is illustrative and not restrictive, and those skilled in the art should understand that unless the context clearly indicates otherwise, the modifier should be understood as “one or more”.

The names of messages or information exchanged between a plurality of apparatuses in the implementations of the present disclosure are used for illustrative purposes only, and are not used to limit the scope of these messages or information.

The solutions provided in the embodiments of the present disclosure are described in detail below with reference to the accompanying drawings.

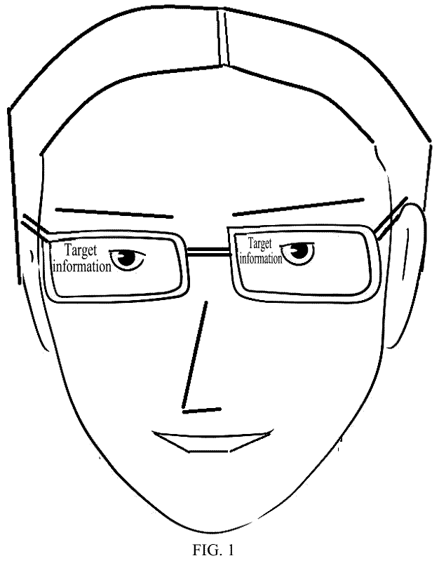

Referring to FIG. 1, a user may enter into a mixed reality space using a mixed reality device such as AR glasses. The mixed reality space includes an image of a real environment that can be viewed through the AR glasses, and display information (such as target information) computationally generated by a processing unit that can be displayed on a display unit (such as lens) of the AR glasses, such as virtual graphics or text. The combination of the image of the real environment and the computationally generated display information realizes the mixing of virtuality and reality.

The mixed reality device is provided with a posture detection sensor (such as a nine-axis sensor) for detecting a posture change of the mixed reality device in real time. If the user wears the mixed reality device, the mixed reality device may transmit a real-time posture of the head to a processor when the user changes a posture of the head, so as to calculate a point of gaze of a line of sight of the user in a mixed reality space environment, and calculate, based on the point of gaze, an image in the mixed reality space environment that is within a range of gaze (i.e., a virtual field of view) of the user and then display the image on the display unit, so that an immersive experience that makes people feel as if they were viewing in a real environment is given.

In the mixed reality world, when the display information is displayed in a 0-degree-of-freedom mode, the display information may not be fixed in the mixed reality world, and thus is rotated and moved totally with the user. In this case, the user gazes at an object in an extended reality world usually by means of coordination of the head and the eyeballs, rather than simply by rolling the eyeballs. However, if the user wears an extended display device and the 0-degree-of-freedom display mode is employed, when the user rotates the head to look at display information (such as target information) that was originally not located in the middle of the field of vision, since the mixed reality device may control the display information to rotate with the rotation of the head of the user so that a relative position of the display information and the head of the user remains unchanged, the display information fails to enter the middle of the line of sight as the user rotates the head, and the user may keep rotating the head to follow the display information, which results in a reduced usage experience of the user. In addition, if the display information is fixedly provided in the middle of the field of vision of the user, this may cause the field of vision of the user to be blocked by the display information in despite of avoiding a need for the user to rotate the head to follow the display information. When the user views the real environment through the display unit of the mixed reality device, the image of the real environment may be blocked by the display information, and a focusing obstruction may be created, which may also cause inconvenience. Therefore, display information that needs to be always displayed within the field of vision of the user should usually be placed in an edge area of the field of vision of the user to avoid the middle of the field of vision, thereby preventing the blocking of the image of the real environment. Furthermore, in the reality world, there is generally no object displayed in the 0-degree-of-freedom mode, and thus the user is prone to a feeling of dizziness when the user gazes at display information with 0 degree of freedom in the extended reality world.

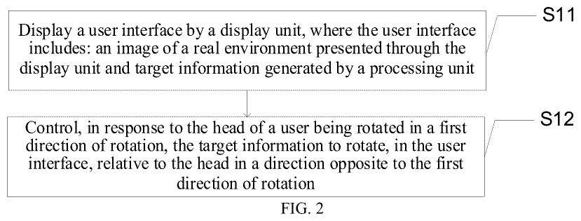

As shown in FIG. 2, FIG. 2 is a flowchart of a display control method according to an embodiment of the present disclosure. The method includes the following steps.

S11: Display a user interface by a display unit, where the user interface includes: an image of a real environment presented through the display unit and target information generated by a processing unit.

In some embodiments, the display unit is communicatively connected to the processing unit, so that the user can view the real environment through the display unit. The method proposed in the present disclosure may be used in the mixed reality device, such as the AR glasses. The display unit may be the lens of the AR glasses, and it may be semi-transparent. After wearing the mixed reality device, the user can see the image of the real environment through the display unit. The target information is information generated by the processing unit. The processing unit may specifically be a processing unit in the mixed reality device, or may be a processing unit of a device other than the mixed reality device, which may be a processor with a computing functionality and is configured to generate the target information. Specifically, taking the processing unit being a processor of the mixed reality device as an example, if the user wears the mixed reality device, the display unit is placed in front of the eyes of the user, and therefore, the display unit needs to be able to make the image of the real environment visible therethrough to avoid obstruction of the line of sight of the user. The processing unit may computationally generate the target information based on user settings or system default settings, and then transmit the target information to the display unit for display. The target information may be displayed on the display unit by means of e.g., projection, etc., and then mixed with the image of the presented real environment to form a mixed reality image. The user interface is an image presented by the user on the display unit, which specifically includes an image of the real environment seen by the user through the display unit and the target information generated by a computing unit. The target information may be text or a picture, for example, it may be a description of or an introduction to an object in the image of the real environment. The target information can be viewed by a user wearing the mixed reality device. The target information may be displayed in the user interface, where the user interface is in the field of vision of the user, and the target information may not be located in the middle of the field of vision.

S12: In response to the head of a user being rotated in a first direction of rotation, control target information to rotate, in the user interface, relative to the head in a direction opposite to the first direction of rotation.

In some embodiments, the mixed reality device may have a motion sensor to detect the motion of the head of the user wearing the mixed reality device. The first direction of rotation may be, for example, upward, downward, leftward, or rightward. During the rotation of the head of the user, the target information is controlled to rotate, with the rotation of the head of the user, relative to the head in the direction opposite to the first direction of rotation. For example, if the head of the user is rotated upward, the target information is rotated downward in the user interface. In this way, when the target information is not displayed in the middle of the field of vision of the user, the user can move the target information to the middle of the field of vision by rotating the head, which makes it easy for the user to view the target information.

In some embodiments of the present disclosure, in a scenario where the mixed reality device is used, the display unit may cover the eyes of the user, but does not interfere with a normal activity of the user in the real environment because the real environment is visible to the user through the display unit. The target information is displayed in the user interface presented by the display unit, and in order to prevent the target information from blocking the field of vision of the user, the target information is usually not located in the middle area of the user interface. Therefore, as the user wants to view the target information, the user may subconsciously rotate the head. In this embodiment, when the user rotates the head in the first direction of rotation, the target information may be rotated relative to the head in the direction opposite to the first direction of rotation, so that the target information may be moved to a desired position for the user in a target interface, so as to be viewed by the user easily, thereby improving the usage experience of the user.

In some embodiments of the present disclosure, a preset boundary is preset. During the rotation of the head in the first direction of rotation, the target information is correspondingly rotated relative to the head in the direction opposite to the first direction of rotation, If the target information is rotated to a preset boundary in the user interface relative to the head in the direction opposite to the first direction of rotation, a position of the target information in the user interface is controlled to remain different. In this case, a relative position of the target information and the head remains unchanged, so that the target information is rotated with the head in the first direction of rotation. When being rotated to the preset boundary, the target information may stop rotation relative to the head, but is rotated with the head. In this case, in the extended reality world, the target information and the head are rotated in a same direction of rotation at a same speed. For the user, the target information is stationary relative to themselves in this case.

In some embodiments of the present disclosure, the proposed method is applicable to a scenario where the target information is rotated with the rotation of the user. When the user rotates the head at a large angle, the target information is rotated roughly in synchronization with the rotation of the head in the same direction; and when the user rotates the head at a small angle, the target information is rotated relative to the head. Therefore, when the user makes an attempt to follow the target information by, e.g., raising the head, the rotation of the head of the user is detected by the motion sensor and the target information is rotated relative to the head in the opposite direction (it may be rotated in the direction opposite to the first direction of rotation by a same angle as the head) to adapt to the line of sight of the user so that the target information can be better viewed. In this way, when the target information is located in an area outside the middle of the field of vision of the user, the target information can be located in the middle of the field of vision by rotating the head of the user. However, when the head is rotated at a large angle, the target information may stop rotation after it reaches the preset boundary, which prevents the target information from moving away the user.

In some embodiments of the present disclosure, the target information is moved with the movement of the head of the user; and before and after the movement of the head, the relative position of the target information and the head remains unchanged. In some embodiments of the present disclosure, the target information is not fixed in the extended reality world, and thus is moved with the user.

In some embodiments of the present disclosure, the target information is always located in the user interface currently displayed to the user, and the preset boundary is a boundary of a preset range in the user interface. In some embodiments, the target information is always displayed in the user interface. The user interface may be within the current field of vision of the user, and therefore, the target information is always located within the field of vision of the user during the rotation of the head of the user. To ensure the display of the target information, the target information cannot be limitlessly moved away with the rotation of the head. Therefore, a fixed range is set in the user interface. When the target information is rotated to the boundary of the preset range, it may stop rotation relative to the head, but is rotated in synchronization with the head.

In some embodiments of the present disclosure, before responding to the rotation of the head of the user, the method further includes: in response to a calibration operation, calibrating a default angle based on current spatial angle information of the display unit, where the default angle is used to determine whether the head of the user has been rotated. In some embodiments, the user may perform a calibration operation to determine a default angle. The default angle (for example, an orientation angle in each of a horizontal direction and a vertical direction) is determined by detecting the spatial angle information through a pose detection component such as a gyroscope. When the display unit is at the default angle, it indicates that the user does not rotate the head, and when the display unit changes control angle information, it indicates that the user has rotated the head.

In some embodiments, calibrating the default angle includes: calibrating a default pitch angle of the head of the user; and/or calibrating a default horizontal angle of the head of the user. In some embodiments, it is necessary to set by default an angle of the head of the user in a natural state. As a reference, the default pitch angle may be an included angle between an orientation of the user when not raising or lowering the head in the vertical direction and a horizontal plane, which may be an angle at which the user is in the most comfortable position of the head, and may be used as a reference to determine whether the user has raised or lowered the head. If the orientation of the head of the user in the vertical direction is at an angle greater than the default pitch angle, it is considered that the user is raising the head, and the target information may be moved downward relative to the head of the user, otherwise it may be moved upward. The default horizontal angle is an angle between an orientation of the user when not rotating the head in the horizontal direction and a default horizontal direction. For example, if the default horizontal direction is east, an included angle between the orientation of the user when not rotating the head in the horizontal direction and the east is the default horizontal angle, which is used as a reference to determine whether the user has rotated the head in the horizontal direction.

In some embodiments of the present disclosure, the method further includes: after the end of the rotation of the head and the target information, using a current horizontal angle at which the user faces as the default horizontal angle. In some embodiments, the user usually does not orient themselves toward one horizontal direction. For example, the user has just oriented themselves toward the east and then turns to west in a moment. When the user completes the rotation to the west, an angle toward the west may be used as the default horizontal angle to continue to determine whether the head has been rotated. Therefore, after the rotation is completed, a current horizontal angle of the user at the end of the rotation is used as the default horizontal angle. The current horizontal angle is the included angle between the orientation in the horizontal direction and the default horizontal direction.

In some embodiments of the present disclosure, the method further includes: after the end of the rotation of the head and the target information, controlling the position of the target information so that the relative position of the target information and the head remains unchanged before and after the rotation of the head in the first direction of rotation. In some embodiments, the relative position of the target information and the head of the user only changes during the rotation of the head of the user, whereas it remains unchanged before and after the rotation of the head of the user. For example, the target information may always be displayed at a preset distance from above the line of sight of the user. Therefore, after the target information is rotated to the preset boundary, the position of the target information may be restored at the end of the rotation of the head of the user.

In some embodiments of the present disclosure, before responding to the rotation of the head of the user in the first direction of rotation, the target information is located outside a middle area of the user interface displayed by the display unit. The user interface is presented in front of the eyes of the user, and should prevent the target information from blocking the field of vision of the user and prevent the external environment from being invisible to the user. The middle of the user interface is the middle of the field of vision of the user in a normal state, and the target information is not located in the middle of the user interface by default, so that the target information cannot block the middle of the field of vision of the user.

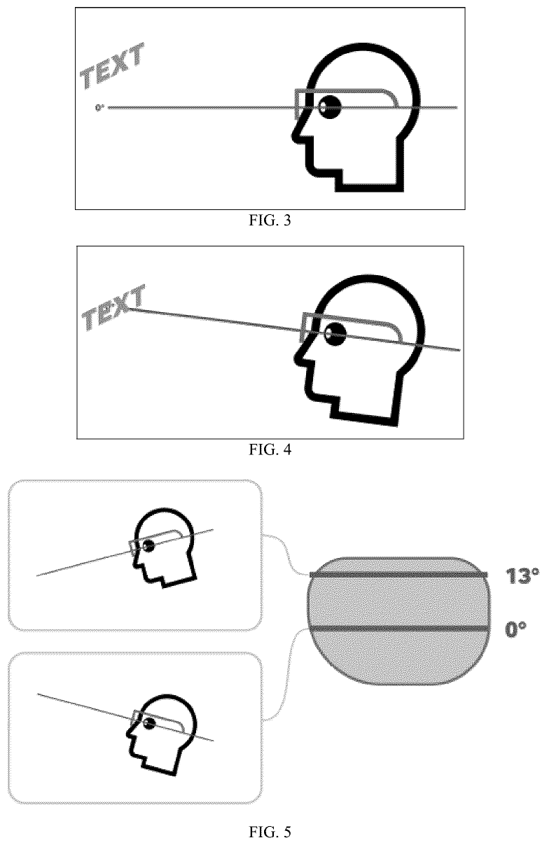

In some embodiments of the present disclosure, the problem of an insufficient user experience when in the 0-degree-of-freedom display mode can be solved. In the 0-degree-of-freedom display mode, if the target information is displayed in the middle of the field of vision of the user, it may block other objects; and if it is displayed outside the middle of the field of vision of the user, for example, above the middle of the field of vision, when the user raises the head to view, the relative position of the target information and the head of the user may automatically remain unchanged. Therefore, the user cannot view the target information by raising the head, which causes inconvenience to use. In some embodiments of the present disclosure, referring to FIG. 3 to FIG. 5, the user wears a mixed display device, the default pitch angle is calibrated, for example, FIG. 3 is the default pitch angle in this case, and the target information (“Text” in FIG. 3) is displayed at a preset distance from above the middle of the field of vision of the user. By taking the user rotating the head in the vertical direction, e.g., raising the head, as an example, when the user rotates the head at an angle less than a threshold, since the user rotates the head upward, the target information is rotated downward relative to the head of the user within the field of vision of the user (see FIG. 4), so that the user can easily read the target information. When the user rotates the head to an angle threshold, the target information reaches the preset boundary of the preset range in the user interface (as shown in FIG. 5, an area of the preset range in the vertical direction is an area delimited, in the user interface, by two slopes that form an included angle of 13 degrees with the horizontal direction). In this case, the target information may remain stationary relative to the head, and if the user continues to raise the head, the target information may be rotated with the head. In the embodiments of the present disclosure, in the application scenario of mixed reality, the display of the target information is coordinated with the motion sensor of the mixed reality device, so as to compensate for, based on the rotation of the head of the user, the rotation of the target information for display, so that the target information can be rotated to the middle of the field of vision of the user, which solves the problem that the target information cannot be captured in the line of sight of the user in the 0-degree-of-freedom display mode. Furthermore, the preset boundary of the preset range is set to ensure that the target information is always displayed within the field of vision of the user. The default pitch angle in the natural state is calibrated to reduce the feeling of dizziness of the user.

In some embodiments of the present disclosure, a display control apparatus is further provided. The apparatus includes:
a processing unit configured to generate target information and communicatively connected to a display unit, so that a user is able to view a real environment through the display unit;
a display unit configured to display a user interface, where the user interface includes: an image of the real environment presented through the display unit and display target information generated by the processing unit; and
a control unit configured to control, in response to the head of the user being rotated in a first direction of rotation, the target information to rotate, in the user interface, relative to the head in a direction opposite to the first direction of rotation,
where during the rotation of the head in the first direction of rotation, if the target information is rotated to a preset boundary relative to the head in the direction opposite to the first direction of rotation, a relative position of the target information and the head is controlled to remain unchanged.

In some embodiments, during the rotation of the head in the first direction of rotation, if the target information is rotated to a preset boundary in the user interface relative to the head in the direction opposite to the first direction of rotation, a position of the target information in the user interface is controlled to remain unchanged.

In some embodiments, the target information is moved with the movement of the head of the user; and
before and after the movement of the head, a relative position of the target information and the head remains unchanged.

In some embodiments, the target information is always located in the user interface currently displayed to the user, and the preset boundary is a boundary of a preset range in the user interface.

In some embodiments, before responding to the rotation of the head of the user in the first direction of rotation, the control unit is further configured to: in response to a calibration operation, calibrate a default angle based on current spatial angle information of the display unit, where the default angle is used to determine whether the head of the user has been rotated.

In some embodiments, calibrating the default angle includes:
calibrating a default pitch angle of the head of the user; and/or
calibrating a default horizontal angle of the head of the user.

In some embodiments, the control unit is further configured to: after the end of the rotation of the head and the target information, control the position of the target information so that the relative position of the target information and the head remains unchanged before and after the rotation of the head in the first direction of rotation.

In some embodiments, before responding to the rotation of the head of the user in the first direction of rotation, the target information is located outside a middle area of the user interface displayed by the display unit.

The apparatus embodiment is substantially corresponding to the method embodiment, and therefore for a related part, reference may be made to the part of the descriptions of the method embodiment. The apparatus embodiment described above is merely illustrative. The modules illustrated as separate modules may be or may not be separate. Some or all of the modules may be selected according to actual needs to achieve the objectives of the solutions of the embodiments, which can be understood and implemented by a person of ordinary skill in the art without involving any inventive effort.

The method and apparatus of the present disclosure have been described above based on the embodiments and application cases. In addition, the present disclosure further provides an electronic device and a computer-readable storage medium. The electronic device and the computer-readable storage medium are described below.

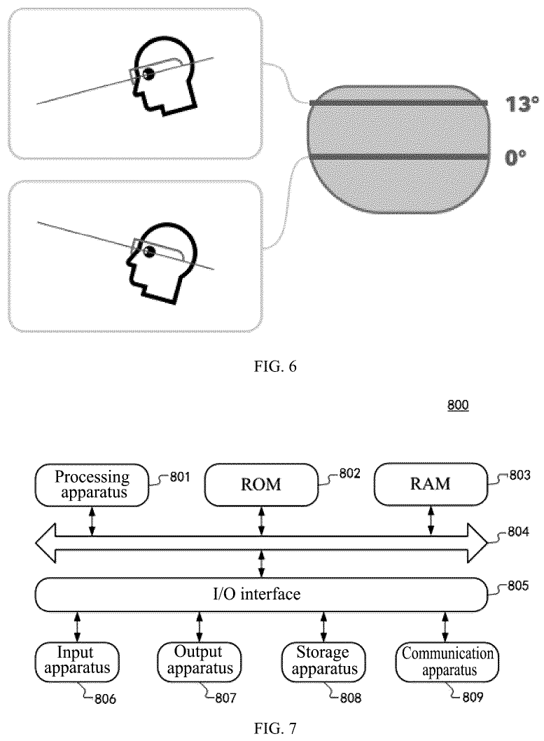

Referring to FIG. 7 below, there is shown a schematic diagram of a structure of an electronic device (such as a terminal device or a server) 800 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in the figure is merely an example, and shall not impose any limitation on the function and scope of use of the embodiments of the present disclosure.

The electronic device 800 may include a processing apparatus (e.g., a central processing unit, a graphics processing unit, etc.) 801 that may perform a variety of appropriate actions and processing in accordance with a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, and a gyroscope; an output apparatus 807 including, for example, a liquid crystal display (LCD), a speaker, and a vibrator; the storage apparatus 808 including, for example, a tape and a hard disk; and a communication apparatus 809. The communication apparatus 809 may allow the electronic device 800 to perform wireless or wired communication with other devices to exchange data. Although the figure shows the electronic device 800 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded from a network through the communication apparatus 809 and installed, installed from the storage apparatus 808, or installed from the ROM 802. When the computer program is executed by the processing apparatus 801, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and the one or more programs, when executed by the electronic device, cause the electronic device to perform the above method according to the present disclosure.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, a display control method is provided, where a display unit is communicatively connected to a processing unit, so that a user is able to view a real environment through the display unit. The method includes:
displaying a user interface by the display unit, where the user interface includes: an image of the real environment presented through the display unit and target information generated by the processing unit; and
controlling, in response to the head of the user being rotated in a first direction of rotation, the target information to rotate, in the user interface, relative to the head in a direction opposite to the first direction of rotation.

According to one or more embodiments of the present disclosure, a display control method is provided, where during the rotation of the head in the first direction of rotation, if the target information is rotated to the preset boundary in the user interface relative to the head in the direction opposite to the first direction of rotation, a position of the target information in the user interface is controlled to remain unchanged.

According to one or more embodiments of the present disclosure, a display control method is provided, where the target information is moved with the movement of the head of the user; and
before and after the movement of the head, a relative position of the target information and the head remains unchanged.

According to one or more embodiments of the present disclosure, a display control method is provided, where the target information is always located in the user interface currently displayed to the user, and the preset boundary is a boundary of a preset range in the user interface.

According to one or more embodiments of the present disclosure, a display control method is provided, where before responding to the rotation of the head of the user in the first direction of rotation, the method further includes:
in response to a calibration operation, calibrating a default angle based on current spatial angle information of the display unit,
where the default angle is used to determine whether the head of the user has been rotated.

According to one or more embodiments of the present disclosure, a display control method is provided, where calibrating a default angle includes:
calibrating a default pitch angle of the head of the user; and/or
calibrating a default horizontal angle of the head of the user.

According to one or more embodiments of the present disclosure, a display control method is provided, where the method further includes:
after the end of the rotation of the head and the target information, controlling the position of the target information so that the relative position of the target information and the head remains unchanged before and after the rotation of the head in the first direction of rotation.

According to one or more embodiments of the present disclosure, a display control method is provided, where before responding to the rotation of the head of the user in the first direction of rotation, the target information is located outside a middle area of the user interface displayed by the display unit.

According to one or more embodiments of the present disclosure, a display control apparatus is provided. The apparatus includes:
a processing unit configured to generate target information and communicatively connected to a display unit, so that a user is able to view a real environment through the display unit;
a display unit configured to display a user interface, where the user interface includes: an image of the real environment presented through the display unit and target information generated by the processing unit; and
a control unit configured to control, in response to the head of the user being rotated in a first direction of rotation, the target information to rotate, in the user interface, relative to the head in a direction opposite to the first direction of rotation.

According to one or more embodiments of the present disclosure, an electronic device is provided. The electronic device includes: at least one memory and at least one processor,
where the at least one memory is configured to store program code, and the at least one processor is configured to call the program code stored in the at least one memory to perform any one of the methods described above.

According to one or more embodiments of the present disclosure, a computer-readable storage medium is provided, which is configured to store program code that, when executed by a processor, causes the processor to perform the method described above.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A display control method, wherein a display unit is communicatively connected to a processing unit, so that a user is able to view a real environment through the display unit, the method comprising:
displaying a user interface by the display unit, wherein the user interface comprises: an image of the real environment presented through the display unit and target information generated by the processing unit; and
controlling, in response to the head of the user being rotated in a first direction of rotation, the target information to rotate, in the user interface, relative to the head in a direction opposite to the first direction of rotation.

2. The method according to claim 1, wherein
during the rotation of the head in the first direction of rotation, in response to the target information being rotated to a preset boundary in the user interface relative to the head in the direction opposite to the first direction of rotation, a position of the target information in the user interface is controlled to remain unchanged.

3. The method according to claim 1, wherein
the target information is moved with the movement of the head of the user; and
before and after the movement of the head, a relative position of the target information and the head remains unchanged.

4. The method according to claim 2, wherein
the target information is always located in the user interface currently displayed to the user, and the preset boundary is a boundary of a preset range in the user interface.

5. The method according to claim 1, wherein before responding to the rotation of the head of the user in the first direction of rotation, the method further comprises:
in response to a calibration operation, calibrating a default angle based on current spatial angle information of the display unit,
wherein the default angle is used to determine whether the head of the user has been rotated.

6. The method according to claim 5, wherein calibrating the default angle comprises:
calibrating a default pitch angle of the head of the user; and/or
calibrating a default horizontal angle of the head of the user.

7. The method according to claim 1, wherein the method further comprises:
after the end of the rotation of the head and the target information, controlling the position of the target information so that the relative position of the target information and the head remains unchanged before and after the rotation of the head in the first direction of rotation.

8. The method according to claim 1, wherein
before responding to the rotation of the head of the user in the first direction of rotation, the target information is located outside a middle area of the user interface displayed by the display unit.

9. An electronic device, comprising:
at least one memory and at least one processor,
wherein the at least one memory is configured to store program code, and the program code, when executed by the at least one processor, causes the electronic device to:
display a user interface by the display unit, wherein the user interface comprises: an image of the real environment presented through the display unit and target information generated by the processing unit; and
control, in response to the head of the user being rotated in a first direction of rotation, the target information to rotate, in the user interface, relative to the head in a direction opposite to the first direction of rotation.

10. The electronic device according to claim 9, wherein
during the rotation of the head in the first direction of rotation, in response to the target information being rotated to a preset boundary in the user interface relative to the head in the direction opposite to the first direction of rotation, a position of the target information in the user interface is controlled to remain unchanged.

11. The electronic device according to claim 9, wherein
the target information is moved with the movement of the head of the user; and
before and after the movement of the head, a relative position of the target information and the head remains unchanged.

12. The electronic device according to claim 10, wherein
the target information is always located in the user interface currently displayed to the user, and the preset boundary is a boundary of a preset range in the user interface.

13. The electronic device according to claim 9, wherein before responding to the rotation of the head of the user in the first direction of rotation, the program code further causes the electronic device to:
in response to a calibration operation, calibrate a default angle based on current spatial angle information of the display unit,
wherein the default angle is used to determine whether the head of the user has been rotated.

14. The electronic device according to claim 13, wherein the program code causes the electronic device to calibrate the default angle further cause the electronic device to:
calibrate a default pitch angle of the head of the user; and/or
calibrate a default horizontal angle of the head of the user.

15. The electronic device according to claim 9, wherein the program code further causes the electronic device to:
after the end of the rotation of the head and the target information, control the position of the target information so that the relative position of the target information and the head remains unchanged before and after the rotation of the head in the first direction of rotation.

16. The electronic device according to claim 9, wherein
before responding to the rotation of the head of the user in the first direction of rotation, the target information is located outside a middle area of the user interface displayed by the display unit.

17. A non-transitory computer-readable storage medium configured to store program code that, when executed by a processor, causes the processor to:
display a user interface by the display unit, wherein the user interface comprises: an image of the real environment presented through the display unit and target information generated by the processing unit; and
control, in response to the head of the user being rotated in a first direction of rotation, the target information to rotate, in the user interface, relative to the head in a direction opposite to the first direction of rotation.

18. The non-transitory computer-readable storage according to claim 17, wherein
during the rotation of the head in the first direction of rotation, in response to the target information being rotated to a preset boundary in the user interface relative to the head in the direction opposite to the first direction of rotation, a position of the target information in the user interface is controlled to remain unchanged.

19. The non-transitory computer-readable storage according to claim 17, wherein
the target information is moved with the movement of the head of the user; and
before and after the movement of the head, a relative position of the target information and the head remains unchanged.

20. The non-transitory computer-readable storage according to claim 18, wherein
the target information is always located in the user interface currently displayed to the user, and the preset boundary is a boundary of a preset range in the user interface.
